(19) United States
(12) Patent Application Publication
(10) Pub. No.: US 2016/0366619 A1
(43) Pub. Date: Dec. 15, 2016

(54) REDUCED HANDOVER FAILURE FOR SINGLE RADIO VOICE CALL CONTINUITY

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/736,229

(22) Filed: Jun. 10, 2015

(51) Int. Cl. H04W 36/00

(52) U.S. Cl. CPC H04W 36/0016; H04W 36/0088

(57) ABSTRACT

A user equipment (UE) reduces handover failure when the UE is prematurely handed over to a target cell during a single radio-voice call continuity (SRVCC) procedure or when the target cell is unavailable. In one instance, the UE prevents handover of a packet-switched (PS) voice call from a serving cell of a PS radio access technology (RAT) to the target cell of a circuit-switched (CS) RAT after the UE sends a measurement report for the target cell but before receiving a handover command. The UE prevents the handover if the target cell becomes undesirable for handover and/or the serving cell becomes desirable for maintaining the PS voice call.

### BACKGROUND

Field

Aspects of the present disclosure relate generally to wireless communication systems, and more particularly to reducing handover failure for single rate voice call continuity (SRVCC).

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes preventing handover of a packet-switched (PS) voice call from a serving cell of a PS radio access technology (RAT) to a target cell of a circuit-switched (CS) RAT after the UE sends a measurement report for the target cell but before receiving a handover command. The UE prevents the handover when the target cell becomes undesirable for handover and/or the serving cell becomes desirable for maintaining the PS voice call.

According to another aspect of the present disclosure, an apparatus for wireless communication includes means for sending a measurement report for a target cell of a circuit-switched target radio access technology (RAT). The apparatus may also include means for preventing handover of the packet-switched voice call from a serving cell of a packet-switched RAT to the target cell of the circuit-switched RAT after sending the measurement report for the target cell of the circuit switched target RAT but before receiving a handover command. The UE prevents the handover when the target cell becomes undesirable for handover and/or the serving cell becomes desirable for maintaining the PS voice call.

Another aspect discloses an apparatus for wireless communication and includes a memory and at least one processor coupled to the memory. The processor(s) is configured to prevent handover of a packet-switched (PS) voice call from a serving cell of a PS radio access technology (RAT) to a target cell of a circuit-switched (CS) RAT after the UE sends a measurement report for the target cell but before receiving a handover command. The UE prevents the handover when the target cell becomes undesirable for handover and/or the serving cell becomes desirable for maintaining the PS voice call.

Yet another aspect discloses a computer program product for wireless communications in a wireless network having a non-transitory computer-readable medium. The computer-readable medium has non-transitory program code recorded thereon which, when executed by the processor(s), causes the processor(s) to prevent handover of a packet-switched (PS) voice call from a serving cell of a PS radio access technology (RAT) to a target cell of a circuit-switched (CS) RAT after the UE sends a measurement report for the target cell but before receiving a handover command. The UE prevents the handover when the target cell becomes undesirable for handover and/or the serving cell becomes desirable for maintaining the PS voice call.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a nodeB in communication with a UE in a telecommunications system.

FIG. 4 illustrates network coverage areas according to aspects of the present disclosure.

FIG. 5 is a block diagram illustrating a wireless communication network in accordance with an aspect of the present disclosure.

FIG. 6 is an exemplary call flow diagram illustrating a signaling procedure in accordance with aspects of the present disclosure.

FIG. 7 is a flow diagram illustrating a wireless communication method according to aspects of the disclosure.

FIG. 8 is a block diagram illustrating an example of a hardware implementation for an apparatus employing a processing system in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

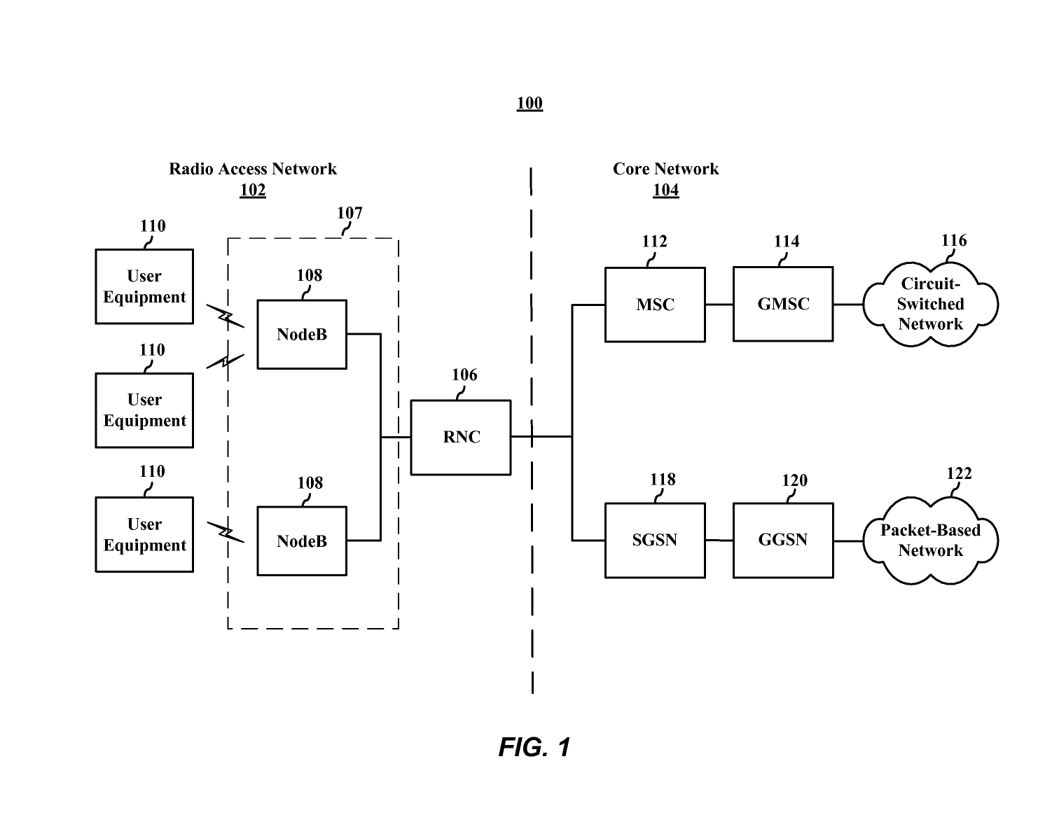

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 108 are shown; however, the RNS 107 may include any number of wireless nodeBs. The nodeBs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the nodeBs 108. The downlink (DL), also called the forward link, refers to the communication link from a nodeB to a UE, and the uplink (UL), also called the reverse link, refers to the communication link from a UE to a nodeB.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. General packet radio service (GPRS) is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 108 and a UE 110, but divides uplink and downlink transmissions into different time slots in the carrier.

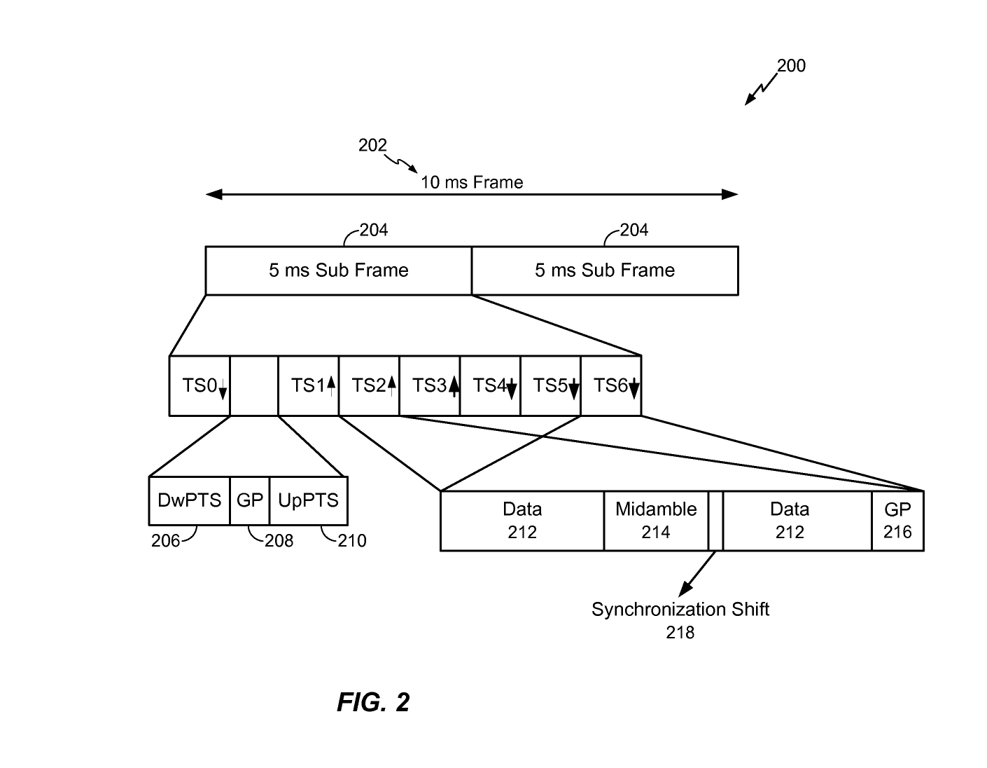

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

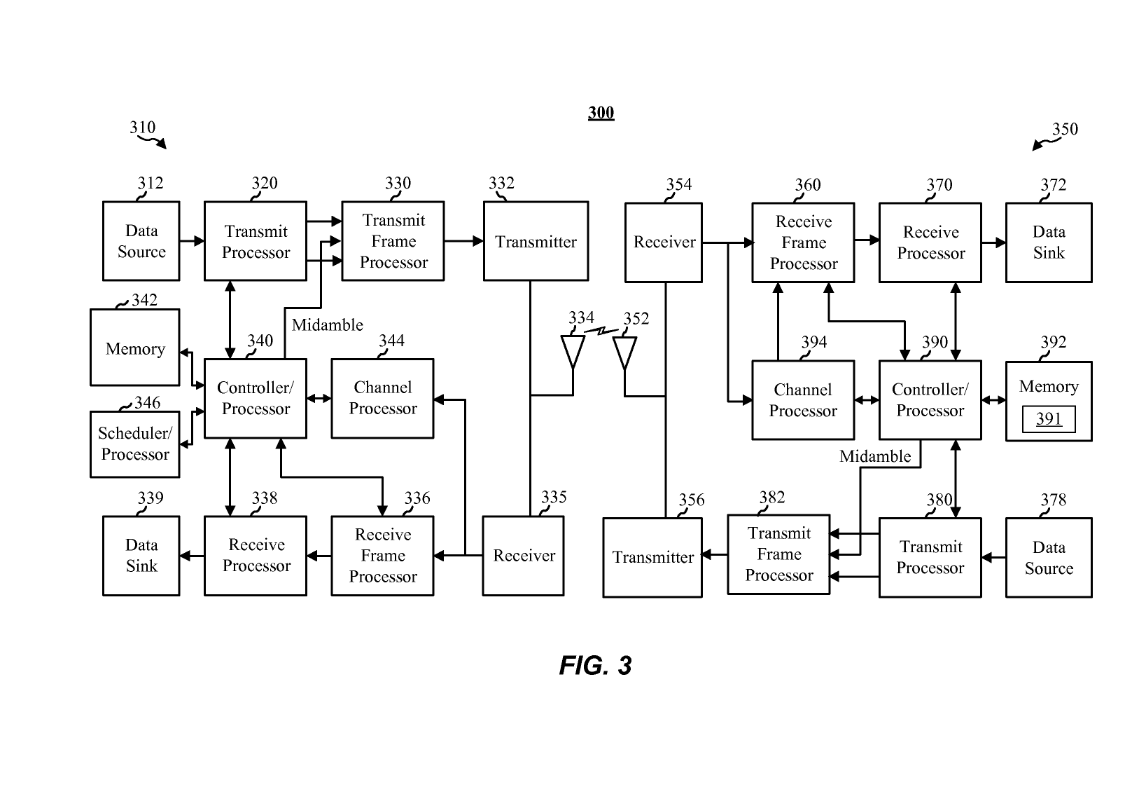

FIG. 3 is a block diagram of a nodeB 310 in communication with a UE 350 in a RAN 300, where the RAN 300 may be the RAN 102 in FIG. 1, the nodeB 310 may be the nodeB 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the nodeB 310. More specifically, the receive processor 370 descrambles and despreads the symbols, and then determines the most likely signal constellation points transmitted by the nodeB 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the nodeB 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the nodeB 310 or from feedback contained in the midamble transmitted by the nodeB 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the nodeB 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the nodeB 310 may be used to allocate resources to the UEs and schedule downlink and/or uplink transmissions for the UEs.

The controller/processors 340 and 390 may be used to direct the operation at the nodeB 310 and the UE 350, respectively. For example, the controller/processors 340 and 390 may provide various functions including timing, peripheral interfaces, voltage regulation, power management, and other control functions. The computer-readable media of memories 342 and 392 may store data and software for the nodeB 310 and the UE 350, respectively. For example, the memory 392 of the UE 350 may store a handover establishment module 391 which, when executed by the controller/processor 390, configures the UE 350 for preventing handover of a packet-switched voice call according to aspects of the present disclosure.

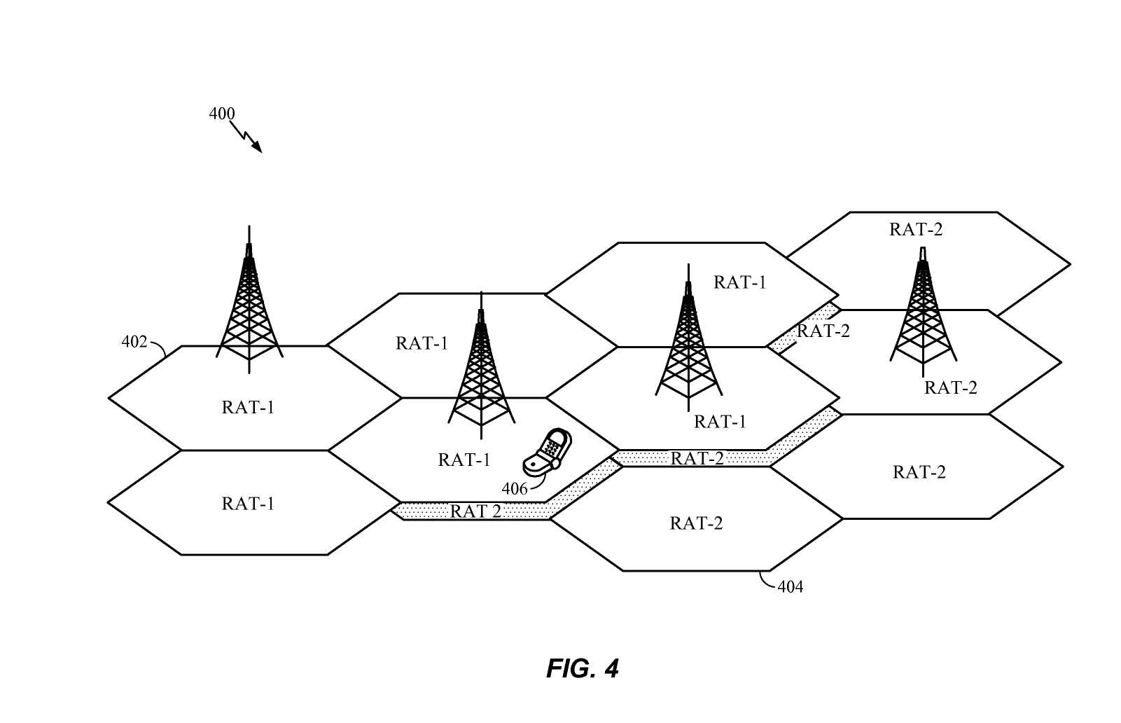

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1) and also illustrates a newly deployed network utilizing a second type of radio access technology (RAT-2). The geographical area 400 may include RAT-1 cells 402 and RAT-2 cells 404. In one example, the RAT-1 cells are LTE cells and the RAT-2 cells are TD-SCDMA cells. In another example, the RAT-1 cells are LTE cells and the RAT-2 cells are GSM cells. However, those skilled in the art will appreciate that other types of radio access technologies may be utilized within the cells. A user equipment (UE) 406 may move from one cell, such as a RAT-1 cell 402, to another cell, such as a RAT-2 cell 404. The movement of the UE 406 may specify a handover.

The handover may be performed when the UE moves from a coverage area of a first RAT to the coverage area of a second RAT, or vice versa. A handover may also be performed when there is a coverage hole or lack of coverage in one network or when there is traffic balancing between a first RAT and the second RAT networks. As part of that handover process, while in a connected mode with a first system (e.g., LTE) a UE may be specified to perform a measurement of a neighboring cell (e.g., TD-SCDMA cell). For example, the UE may measure the neighbor cells of a second network for signal strength, frequency channel, and base station identity code (BSIC). The UE may then connect to the strongest cell of the second network. Such measurement may be referred to as inter-radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Single radio voice call continuity (SRVCC) is a solution aimed at providing continuous voice services on packet-switched networks (e.g., LTE networks). In the early phases of LTE deployment, when user equipments (UEs) running voice services move out of an LTE network, the voice services can continue in the legacy circuit-switched (CS) domain using SRVCC, ensuring voice service continuity. SRVCC is a method of inter-radio access technology (IRAT) handover. SRVCC enables smooth session transfers from voice over internet protocol (VoIP) over the IP multimedia subsystem (IMS) on the LTE network to circuit-switched services in the universal terrestrial radio access network (UTRAN) or GSM enhanced date rates for GSM Evolution (EDGE) radio access network (GERAN).

LTE coverage is limited in availability. When a UE that is conducting a packet-switched voice call (e.g., voice over LTE (VoLTE) call) leaves LTE coverage or when LTE network is highly loaded, SRVCC may be used to maintain voice call continuity from a packet-switched (PS) call to a circuit-switched call during IRAT handover scenarios. SRVCC may also be used, for example, when a UE has a circuit-switched voice preference (e.g., circuit-switched fallback (CSFB)) and packet-switched voice preference is secondary if combined attach fails. The evolved packet core (EPC) may send an accept message for PS Attach in which case a VoIP/IMS capable UE initiates a packet-switched voice call.

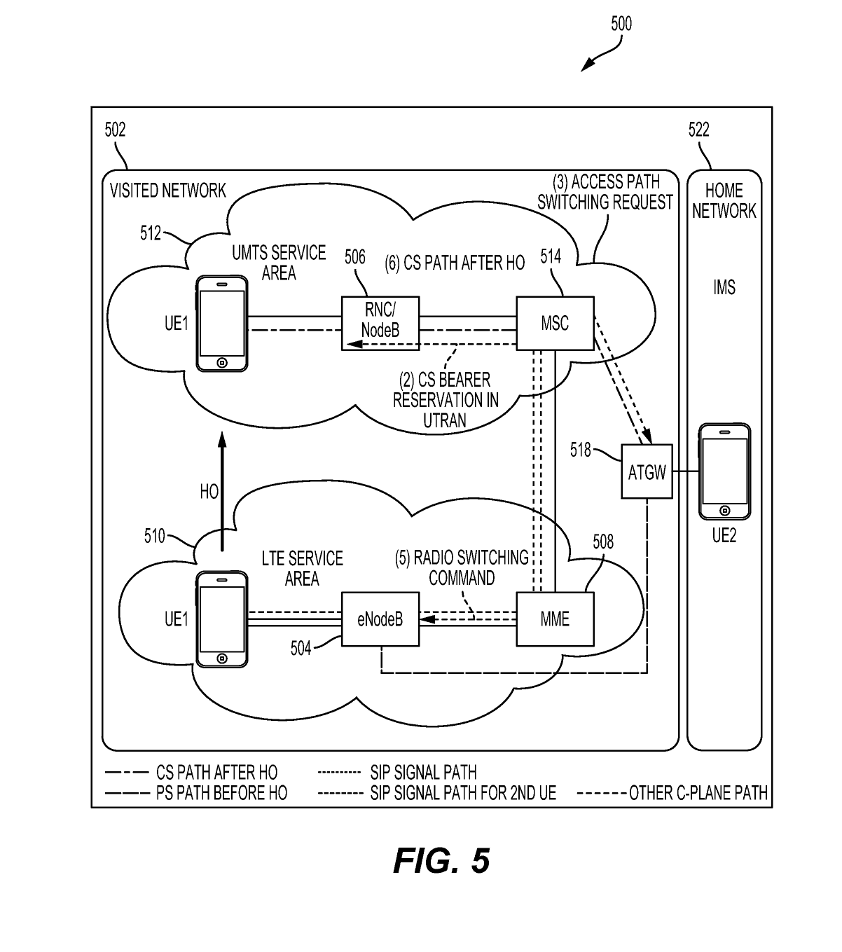

A UE may perform an LTE serving cell measurement. When the LTE serving cell signal strength or quality is below a threshold, the UE may report an event 2A (change of the best frequency), then the LTE network may send radio resource control (RRC) reconfiguration messages indicating 2G/3G neighbor frequencies, event B1 (neighbor cell becomes better than an absolute threshold) and or B2 (a serving RAT becomes worse than a threshold and the inter-RAT neighbor become better than another threshold). The LTE network may also send LTE measurement gaps. For example, the measurement gap for LTE is a 6 ms gap that occurs every 40 or 80 ms. The UE uses the measurement gap to perform 2G/3G measurements and LTE inter-frequency measurements. When the LTE eNodeB receives the event B1 report from the UE, the LTE eNodeB may initiate the SRVCC procedure. The SRVCC procedure may be implemented in a wireless network, such as the wireless network of FIG. 5.

FIG. 5 is a block diagram illustrating a wireless communication network 500 in accordance with aspects of the present disclosure. Referring to FIG. 5, the wireless communication network may include a visited network 502 and a home network 522. The visited network 502 may include multiple service areas. For example, as shown in FIG. 5, without limitation, the visited network 502 may include an LTE service area 510 and a UMTS service area 512. A first UE (UE1) located in the LTE service area 510 may conduct a voice call with a second UE (UE2), which is located in the home network 522. In one aspect, UE1 may conduct a voice call (e.g., a PS call or VoLTE) with UE2 via the access transfer gateway (ATGW) 518.

When UE1 leaves the LTE service area 510, the LTE serving cell (eNodeB 504) signal strength or signal quality may fall below a threshold. As such, UE1 may report an event 2A. In turn, the eNodeB 504 may provide an RRC connection reconfiguration message to UE1. The RRC connection reconfiguration message may include measurement configuration information such as the LTE measurement gap allocation. For example, the LTE gap allocation may be such that a 6 ms measurement gap occurs every 40 ms.

Accordingly, UE1 may conduct the IRAT and inter-frequency measurements and provide a corresponding measurement report to the eNodeB 504, which may initiate the handover of coverage to the NodeB 506 of the UMTS service area 512. The mobility management entity (MME) 508 may initiate an SRVCC procedure for the handover. A switch procedure may be initiated to transfer the voice call to a circuit-switched network. An access path switching request is sent via the mobile switching center (MSC) 514, which routes the voice call to UE2 via the access transfer gateway (ATGW) 518. Thereafter, the call between UE1 and UE2 may be transferred to a circuit-switched call.

When the UE performs handover to a target cell (e.g., of the circuit-switched network) after receiving a handover command, in certain undesirable events, a handover failure occurs. Alternatively, the handover failure occurs when the UE leaves the packet-switched network (e.g., LTE network) prematurely, especially if there is a concurrent packet-switched call in parallel with a voice over LTE (VoLTE) call. For example, an undesirable event occurs when the UE cannot detect GSM channels, such as a frequency correction channel (FCCH) or the UE fails to decode a synchronization channel (SCH) after the UE sends the B1 or B2 report for a target GSM cell, before receiving a handover command. For example, the undesirable event may be caused by a location change (e.g., the UE enters a high-speed train.) That is, the UE cannot detect FCCH or fails to decode SCH when the UE leaves the target cell coverage in a high-speed train, for example.

Alternatively, an undesirable event occurs when the LTE serving or a different intra- or inter-frequency neighbor cells become better (i.e., signal quality of the cell is above a predefined threshold) and the UE still performs the handover to the target cell. When the UE performs handover to the target cell after receiving a handover command, in these cases, a handover failure may occur. Alternatively, the UE leaves the LTE serving cell prematurely, especially when there is a concurrent packet-switched call in parallel with the VoLTE call.

### Reduced Handover Failure for Single Radio Voice Call Continuity

Aspects of the disclosure are directed to reducing handover failure when a user equipment (UE) is prematurely handed over to a target cell during a single radio-voice call continuity (SRVCC) procedure or when the target cell is unavailable. In one aspect of the disclosure, the UE does not perform a handover procedure and directly sends a handover failure indication to a serving radio access technology (RAT) (e.g., packet-switched (PS) RAT such as LTE). The UE sends the handover rejection indication after an undesirable event occurs when the UE receives a handover command. For example, the UE prevents handover of a packet-switched voice call (e.g., voice over LTE) from a packet-switched serving RAT to a target RAT (e.g., circuit-switched target RAT).

In one aspect of the disclosure, the handover is prevented when the UE sends a measurement report (e.g., B1 or B2) for a cell of the target RAT (e.g., GSM) that becomes undesirable for handover. In this aspect, the cell of the target RAT becomes undesirable for handover after the UE sends a measurement report but before receiving a handover command. For example, the cell of the target RAT becomes undesirable for handover when the target cell becomes weak after sending the measurement report but before receiving the handover command. The target cell may be deemed weak when a signal quality of the target cell fails to meet a threshold value.

In addition to or alternative to preventing the handover when the target RAT becomes undesirable, the handover is prevented when a serving cell or neighbor cells of a packet-switched RAT become desirable for maintaining the packet-switched voice call. That is, the handover is prevented after sending the measurement report but before receiving the handover command. The serving cell or the neighbor cells may be deemed desirable or strong when a signal quality of the serving cell or neighbor cells meet a threshold value.

As noted, the UE prevents the handover by sending the handover rejection indication without performing the handover procedure. For example, the UE sends the handover rejection indication after receiving the handover command. In one aspect, the handover rejection indication may be sent immediately after receiving the handover command. Thus, the UE does not attempt to handover to the target RAT. The handover procedure may include tuning a frequency from the packet-switched RAT (e.g., LTE) to a different RAT, such as a second/third generation RAT.

In one aspect of the disclosure, the UE sends a measurement report for intra-frequency and or inter-frequency neighbor cells of the packet-switched RAT after sending the handover rejection indication. In this case, the measurement report is sent when a signal quality of a neighbor cell of the packet-switched RAT becomes higher than a threshold, after sending the handover rejection indication. The measurement report may include an event 2A, B1 or B2 measurement report.

In another aspect of the disclosure, the UE sends a measurement report for a neighbor cell of the circuit-switched target RAT after sending the handover rejection indication. In this case, the measurement report is sent when a signal quality of the neighbor cell becomes higher than a threshold after sending the handover rejection indication.

In yet another aspect of the present disclosure, the UE stays on the serving cell when a signal quality of the serving cell becomes higher than a threshold after sending the handover rejection indication.

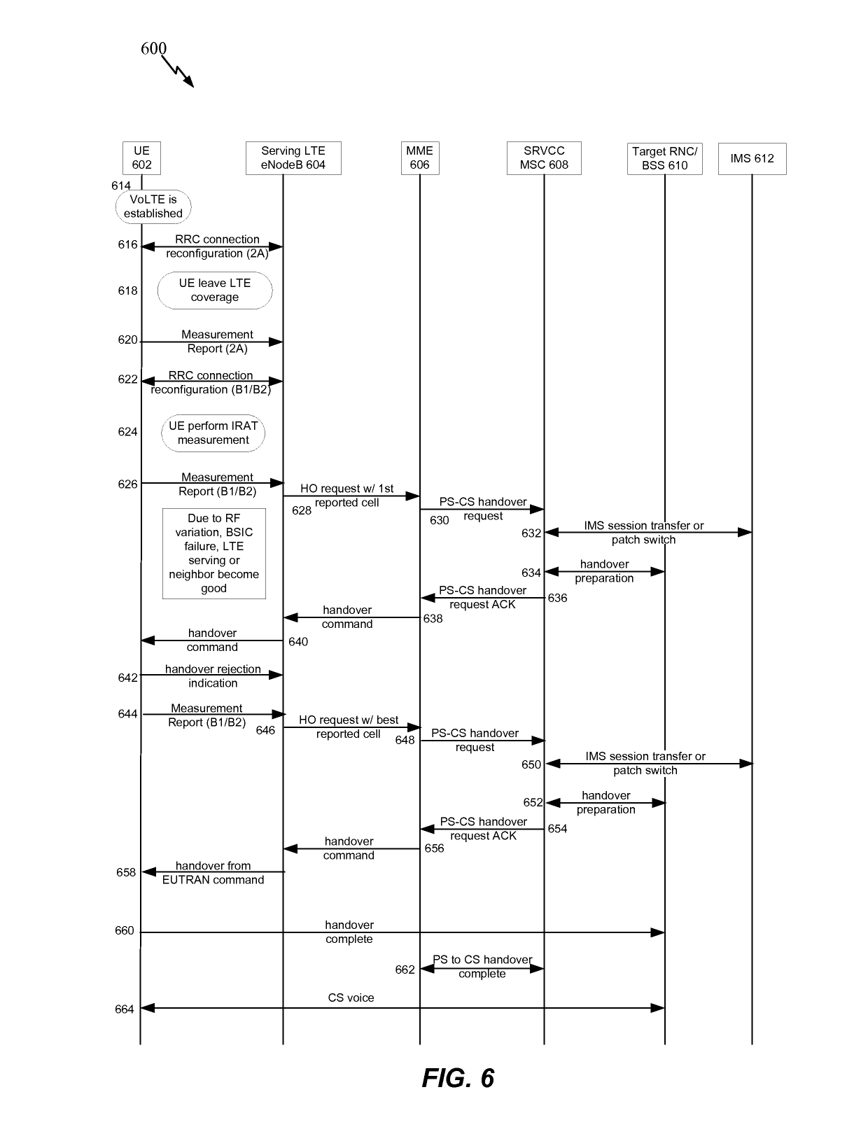

FIG. 6 is an exemplary call flow diagram 600 illustrating a signaling procedure in accordance with aspects of the present disclosure. At time 614, a user equipment (UE) 502 is in an original operation mode, such as a connected mode or a dedicated channel (DCH) mode with a packet-switched (PS) RAT (e.g., LTE). For example, in one aspect, the UE may conduct a voice call (e.g., a PS call or VoLTE) via the serving LTE eNodeB 604.

At time 616, the serving LTE eNodeB 604 sends a first radio resource control (RRC) connection reconfiguration message to a UE 602. The first RRC connection configuration message may include the measurement configuration with information about the measurement gap resources. For example, the first RRC connection configuration message may be directed to inter-frequency handover measurements and events, such as event 2A. The event 2A based RRC connection configuration message may result from the UE leaving a coverage area of the serving LTE eNodeB 604, at time 618. At time 620, the UE 602 sends an event 2A measurement report to the serving LTE eNodeB 604.

In some aspects, the serving LTE eNodeB 604 sends a second RRC connection reconfiguration message to the UE 602. The second RRC connection configuration message may also include the measurement configuration with information about the measurement gap resources. For example, the second RRC connection configuration message may be directed to event B1 when an inter-RAT neighbor becomes better than a threshold. The second RRC connection configuration message may also be directed to event B2 when a serving RAT becomes worse than a threshold and the inter-RAT neighbor become better than another threshold. At time 624, the UE 602 performs the inter-RAT measurement. At time 626, the UE 602 sends an event B1/B2 measurement report to the serving LTE eNodeB 604.

The serving LTE eNodeB 604 provides an indication of whether handover is desirable (e.g., with a first reported cell) to a mobility management entity (MME) 606, at time 628. In turn, at time 630, the mobility management entity 606 initiates SRVCC for circuit-switched (CS) and packet-switched (PS) handovers. For example, the mobility management entity 606 transmits a packet-switched to circuit-switched handover request to an SRVCC mobile switching center (MSC) server 608. In turn, at time 632, the SRVCC mobile switching center server 608 begins an internet protocol multimedia subsystem (IMS) service continuity procedure with an internet protocol multimedia subsystem 612. The procedure may include an internet protocol multimedia subsystem session transfer procedure or a path switch procedure. For example, the path switch procedure includes switching a voice communication path from LTE to 2G or 3G.

At time 634, the SRVCC mobile switching center server 608 begins circuit-switched/packet-switched handover preparation with a target radio network controller (RNC)/base station subsystem (BSS) 610. At time 636, the SRVCC mobile switching center server 608 sends a handover response message to the mobility management entity 606. The handover response message may include a packet-switched to circuit-switched handover request acknowledgment (ACK). At time 638, the mobility management entity 606 sends a message to the eNodeB 604 including a handover command. At time 640, the eNodeB 604 provides a handover command to the UE 602 instructing the UE to handover communications from the eNodeB 604 to the target radio network controller (RNC)/base station subsystem (BSS) 610.

In one aspect, however, the handover procedure may be inappropriate. For example, the UE 602 may be instructed to handover to the target radio network controller (RNC)/base station subsystem (BSS) 610 during an SRVCC procedure when a target cell is unavailable. In this aspect, the UE 602 does not perform the handover procedure. Rather, at time 642, the UE directly sends a handover rejection indication to the serving RAT (e.g., eNodeB 604) to prevent the handover. The handover rejection indication may be sent, at time 642, after receiving the handover command to prevent the handover.

In some aspects, the handover is prevented when the UE 602 sends a measurement report (e.g., B1 or B2) for a cell of the target radio network controller (RNC)/base station subsystem (BSS) 610 that becomes undesirable for handover. In this aspect, the cell of the target radio network controller (RNC)/base station subsystem (BSS) 610 becomes undesirable for handover after the UE 602 sent a measurement report but before receiving a handover command. The handover may be prevented for other reasons discussed herein.

When the handover procedure is prevented, the UE 602 may initiate another handover procedure to successfully hand over the UE 602 from the eNodeB 604 to the target radio network controller (RNC)/base station subsystem (BSS) 610. For example, the new handover procedure may be initiated when a different cell of the target radio network controller (RNC)/base station subsystem (BSS) 610 meets a threshold or the initial target cell becomes stronger. The handover procedure may also be initiated for an inter-frequency or intra-frequency neighbor cell when the inter-frequency or intra-frequency neighbor cell meets a threshold. However, if the serving cell becomes stronger (i.e., meets a threshold) the UE stays on the serving cell and a handover procedure is prevented.

The new handover procedure, at times 644-658, may be similar to the procedures described for times 626-640. For example, at time 644, the UE 602 sends an event B1/B2 measurement report to the serving LTE eNodeB 604. At time 646, the serving LTE eNodeB 604 provides an indication of whether handover is desirable (e.g., with a best reported cell) to a mobility management entity (MME) 606.

At time 648, the mobility management entity 606 initiates SRVCC for circuit-switched (CS) and packet-switched (PS) handovers. At time 650, the SRVCC mobile switching center server 608 begins an internet protocol multimedia subsystem (IMS) service continuity procedure with an internet protocol multimedia subsystem 612. At time 652, the SRVCC mobile switching center server 608 begins circuit-switched/packet-switched handover preparation with a target radio network controller (RNC)/base station subsystem (BSS) 610. At time 654, the SRVCC mobile switching center server 608 sends a handover response message to the mobility management entity 606. At time 656, the mobility management entity 606 sends a message to the eNodeB 604 including the handover command. At time 658, the eNodeB 604 provides a handover command to the UE 602 instructing the UE to handover communications from the eNodeB 604 to the target radio network controller (RNC)/base station subsystem (BSS) 610.

In the new handover procedure, however, the target cell is available and the UE 602 is not prematurely handed over to the target cell. Accordingly, after receiving the handover command at time 660, a handover complete message is sent to the target radio network controller (RNC)/base station subsystem (BSS) 610. At time 662, the SRVCC mobile switching center server 608 completes circuit-switched/packet-switched handover with the mobility management entity 606. At time 664, the circuit-switched voice call is established with the target radio network controller (RNC)/base station subsystem (BSS) 610.

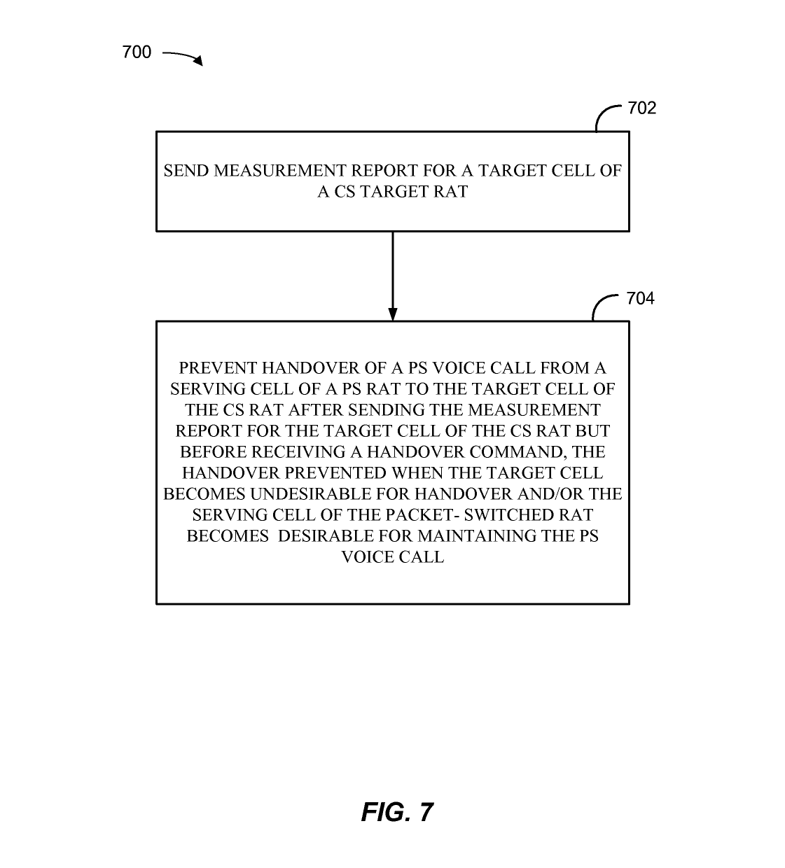

FIG. 7 shows a wireless communication method 700 according to one aspect of the disclosure. A user equipment (UE) sends a measurement report for a target cell of a circuit-switched target radio access technology (RAT), as shown in block 702. The UE prevents handover of the packet-switched voice call from the serving cell of a packet-switched RAT to the target cell of the circuit-switched RAT after sending the measurement report for the target cell of the circuit switched RAT but before receiving the handover command, as shown in block 704. The handover may be prevented when the target cell becomes undesirable for handover and/or the serving cell of the packet-switched RAT becomes desirable for maintaining the packet-switched voice call.

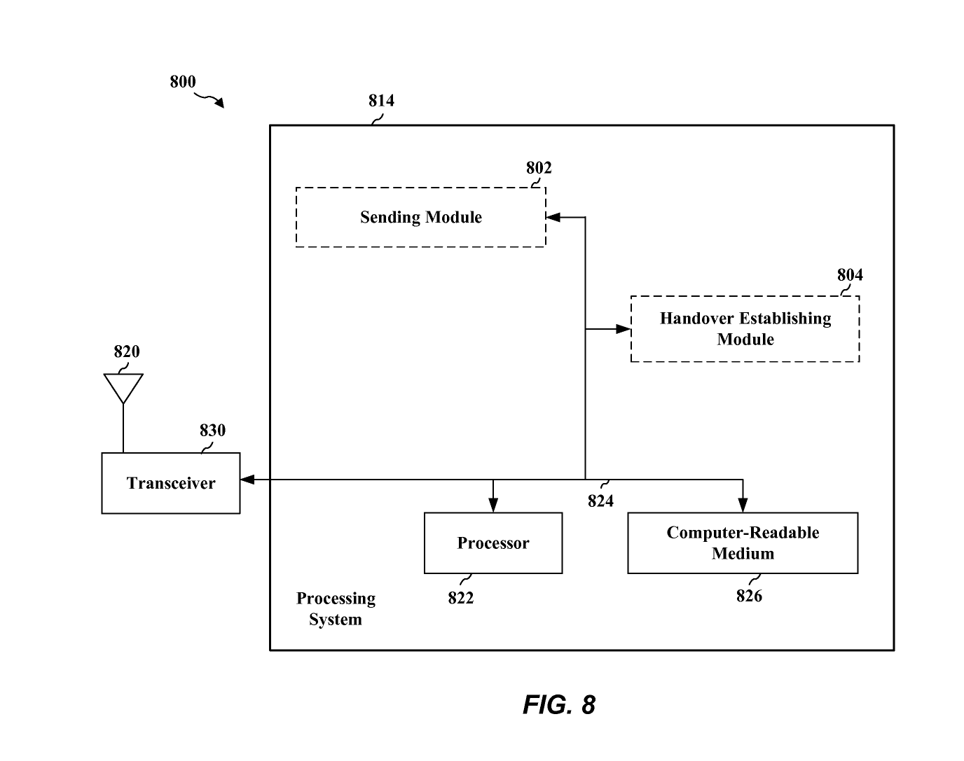

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804 and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a sending module 802 for sending a measurement report for a target cell. The processing system 814 includes a handover establishing module 804 for preventing handover of the packet-switched voice call from the serving cell of a packet-switched RAT to the target cell of the circuit-switched RAT. The modules may be software modules running in the processor 822, resident/stored in the computer-readable medium 826, one or more hardware modules coupled to the processor 822, or some combination thereof. The processing system 814 may be a component of the UE 350 and may include the memory 392, and/or the controller/processor 390.

In one configuration, an apparatus such as a UE is configured for wireless communication including means for sending. In one aspect, the sending means may be the antenna 352/820, the transmitter 356, the transceiver 830, the transmit frame processor 382, the transmit processor 380, the controller/processor 390, the memory 392, the handover establishment module 391, the sending module 802 and/or the processing system 814 configured to perform the aforementioned means. In one configuration, the means functions correspond to the aforementioned structures. In another aspect, the aforementioned means may be a module or any apparatus configured to perform the functions recited by the aforementioned means.

The UE is also configured to include means for preventing. In one aspect, the preventing means may be the antennas 352/820, the receiver 354, the transmitter 356, the transceiver 830, the channel processor 394, the receive frame processor 360, the receive processor 370, transmit frame processor 382, the transmit processor 380, the controller/processor 390, the memory 392, the handover establishment module 391, the handover establishing module 804, and/or the processing system 814 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to TD-SCDMA, LTE and GSM systems. As those skilled in the art will readily appreciate, various aspects described throughout this disclosure may be extended to other telecommunication systems, network architectures and communication standards including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
preventing handover of a packet-switched voice call from a serving cell of a packet-switched radio access technology (RAT) to a target cell of a circuit-switched RAT after a user equipment (UE) sends a measurement report for the target cell of the circuit-switched RAT and if the target cell becomes undesirable for handover and/or the serving cell of the packet-switched RAT becomes desirable for maintaining the packet-switched voice call, after sending the measurement report but before receiving a handover command.

2. The method of claim 1, in which the target cell becomes undesirable for handover when a signal quality of the target cell fails to meet a threshold.

3. The method of claim 1, in which the serving cell or neighbor cells of the packet-switched RAT become desirable when a signal quality of the serving cell or neighbor cells meet another threshold.

4. The method of claim 1, in which preventing the handover comprises sending a handover failure indication, without performing a handover procedure, immediately after receiving the handover command.

5. The method of claim 4, further comprising sending a measurement report for intra-frequency and/or inter-frequency neighbor cells of the packet-switched RAT when a signal quality of a neighbor cell of the packet-switched RAT becomes higher than a threshold after sending the handover failure indication.

6. The method of claim 4, further comprising sending a measurement report for a neighbor cell of the circuit-switched RAT when a signal quality of the neighbor cell becomes higher than a threshold after sending the handover failure indication.

7. The method of claim 4, further comprising staying on the serving cell when a signal quality of the serving cell becomes higher than a threshold after sending the handover failure indication.

8. An apparatus for wireless communication, comprising:
means for sending a measurement report for a target cell of a circuit-switched target radio access technology (RAT); and
means for preventing handover of a packet-switched voice call from a serving cell of a packet-switched RAT to the target cell of the circuit-switched target RAT after sending the measurement report for the target cell of the circuit-switched target RAT but before receiving a handover command when the target cell becomes undesirable for handover and/or the serving cell of the packet-switched RAT becomes desirable for maintaining the packet-switched voice call.

9. The apparatus of claim 8, in which the target cell becomes undesirable for handover when a signal quality of the target cell fails to meet a threshold.

10. The apparatus of claim 8, in which the serving cell or neighbor cells of the packet-switched RAT become desirable when a signal quality of the serving cell or neighbor cells meet another threshold.

11. The apparatus of claim 8, in which the preventing means further comprises means for sending a handover failure indication, without performing a handover procedure, immediately after receiving the handover command.

12. The apparatus of claim 11, further comprising means for sending a measurement report for intra-frequency and/or inter-frequency neighbor cells of the packet-switched RAT when a signal quality of a neighbor cell of the packet-switched RAT becomes higher than a threshold after sending the handover failure indication.

13. The apparatus of claim 11, further comprising means for sending a measurement report for a neighbor cell of the circuit-switched RAT when a signal quality of the neighbor cell becomes higher than a threshold after sending the handover failure indication.

14. The apparatus of claim 11, further comprising means for causing a user equipment (UE) to stay on the serving cell when a signal quality of the serving cell becomes higher than a threshold after sending the handover failure indication.

15. An apparatus for wireless communication, comprising:
a memory; and
at least one processor coupled to the memory and configured:
to prevent handover of a packet-switched voice call from a serving cell of a packet-switched radio access technology (RAT) to a target cell of a circuit-switched RAT after a user equipment (UE) sends a measurement report for the target cell of the circuit-switched RAT and when the target cell becomes undesirable for handover and/or the serving cell of the packet-switched RAT becomes desirable for maintaining the packet-switched voice call, after sending the measurement report but before receiving a handover command

16. The apparatus of claim 15, in which the target cell becomes undesirable for handover when a signal quality of the target cell fails to meet a threshold.

17. The apparatus of claim 15, in which the serving cell or neighbor cells of the packet-switched RAT become desirable when a signal quality of the serving cell or neighbor cells meet another threshold.

18. The apparatus of claim 15, in which the at least one processor is configured to prevent the handover by sending a handover failure indication, without performing a handover procedure, immediately after receiving the handover command.

19. The apparatus of claim 18, in which the at least one processor is further configured to send a measurement report for intra-frequency and/or inter-frequency neighbor cells of the packet-switched RAT when a signal quality of a neighbor cell of the packet-switched RAT becomes higher than a threshold after sending the handover failure indication.

20. The apparatus of claim 18, in which the at least one processor is further configured to send a measurement report for a neighbor cell of the circuit-switched RAT when a signal quality of the neighbor cell becomes higher than a threshold after sending the handover failure indication.

21. The apparatus of claim 18, in which the at least one processor is further configured to cause the UE to stay on the serving cell when a signal quality of the serving cell becomes higher than a threshold after sending the handover failure indication.

22. A computer program product for wireless communication, comprising:
a non-transitory computer-readable medium having program code recorded thereon, the program code comprising:
program code to prevent handover of a packet-switched voice call from a serving cell of a packet-switched radio access technology (RAT) to a target cell of a circuit-switched RAT after a user equipment (UE) sends a measurement report for the target cell of the circuit-switched RAT and when the target cell becomes undesirable for handover and/or the serving cell of the packet-switched RAT becomes desirable for maintaining the packet-switched voice call, after sending the measurement report but before receiving a handover command.

23. The computer program product of claim 22, in which the target cell becomes undesirable for handover when a signal quality of the target cell fails to meet a threshold.

24. The computer program product of claim 22, in which the serving cell or neighbor cells of the packet-switched RAT become desirable when a signal quality of the serving cell or neighbor cells meet another threshold.

25. The computer program product of claim 22, in which the program code to prevent the handover further comprises program code to send a handover failure indication, without performing a handover procedure, immediately after receiving the handover command.

26. The computer program product of claim 25, further comprising program code to send a measurement report for intra-frequency and/or inter-frequency neighbor cells of the packet-switched RAT when a signal quality of a neighbor cell of the packet-switched RAT becomes higher than a threshold after sending the handover failure indication.

27. The computer program product of claim 25, further comprising program code to send a measurement report for a neighbor cell of the circuit-switched RAT when a signal quality of the neighbor cell becomes higher than a threshold after sending the handover failure indication.

28. The computer program product of claim 25, further comprising program code to cause the UE to stay on the serving cell when a signal quality of the serving cell becomes higher than a threshold after sending the handover failure indication.
